(19) United States
(12) Patent Application Publication
(10) Pub. No.: US 2016/0025998 A1
(43) Pub. Date: Jan. 28, 2016

(54) DEVICE FOR RAPID DETACHMENT OF EYEWEAR

(71) Applicants: Greg RUHLAND, Hilo, HI (US); Stuart GHERINI, Sacramento, CA (US)

(72) Inventors: Greg RUHLAND, Hilo, HI (US); Stuart GHERINI, Sacramento, CA (US)

(21) Appl. No.: 14/804,679

(22) Filed: Jul. 21, 2015

Related U.S. Application Data
(60) Provisional application No. 62/027,707, filed on Jul. 22, 2014.

(51) Int. Cl. G02C 3/00; G02C 13/00

(52) U.S. Cl. CPC G02C 3/006; G02C 13/001; G02C 2200/02

(57) ABSTRACT

An eyewear detachment device may comprise a first and second assembly in communication with conventional eyewear such as glasses. Each assembly may comprise an attachment mechanism for coupling to a temple retaining portion of the eyewear. At least one band is coupled to the attachment mechanism with proximal and distal portions, wherein the proximal portion is in communication with the attachment mechanism. A detachment mechanism is positioned on the distal portion of the at least one band. The first and second assemblies removably couple to each other at respective detachment mechanisms, wherein a predetermined movement causes the detachment mechanisms to rapidly detach from each other.

### CROSS-REFERENCE TO RELATED APPLICATIONS

This application claims priority to U.S. provisional patent application No. 62/027,707 entitled “DEVICE FOR RAPID DETACHMENT OF EYEWEAR” and filed Jul. 22, 2014, the contents of which are incorporated herein by reference in their entirety as if set forth verbatim.

### FIELD

The present disclosure generally relates to eyewear, and more particularly, to a device for rapid detachment of eyewear retainers once donned by a subject.

### BACKGROUND

The present disclosure relates to rapid detachment of eyewear retention devices. For purposes of this application, eyewear may include eyeglasses, protective eyewear, goggles, sunglasses, or the like. Eyewear typically includes one or more lenses to cover the subject's eyes, a portion that sits on the ridge of the subject's nose, and elongated members that extend from the face of the subject rearwards towards the ears and terminating adjacent to the temple section of the subject.

Since the beginning of eyewear, humans have conceived of systems to more easily retain the eyewear to the subject during use. Such systems have included bands, leashes, cables, strings, chains, and ropes, each of various materials and constructions (“hereinafter band system”), that affix to the temple retaining portion of the eyewear. This causes the eyewear to be secured to the subject so that the eyewear does not otherwise unexpectedly fall therefrom.

While previous approaches have made improvements to the field by focusing on the temple portion or the band systems, each approach is difficult to ultimately remove from the subject once installed on the eyewear and worn by the subject. For example, once previously disclosed eyewear retention devices are installed in the eyewear, the band system that provides operative communication between opposing temple portions of the eyewear must be lifted entirely over the head of the user to be removed or alternatively, disconnected at the temple retaining portions themselves.

Lifting the band system over the head is cumbersome since it can contact and disrupt other garments or articles that may be worn on the subject's head. Significantly, the capability of rapidly detaching eyewear would be particularly advantageous during certain surgical procedures. For example, when the subject is wearing eyewear such as leaded glasses and a portion of the surgical procedure involving the use of X-rays is completed and the eyewear needs to be removed from the surgeon. Current approaches can only be removed by the surgeon by lifting over the head which in a surgical setting is terribly unsafe.

Further, if the subject has long hair, this will require the subject to negotiate the hair through the band system as the eyewear is lifted over the head before the eyewear can be removed from the subject. If the subject endeavors to remove the eyewear retaining device by removing it from the temple retaining portions, this still requires both hands of the subject to simultaneously maintain the eyewear and the retaining device as well as meticulous disengagement of the two articles before the eyewear can be successfully removed from the subject.

While it is evident that eyewear retention devices have been developed, there still exists a great need for an eyewear retention device that can be rapidly and easily coupled to any type of eyewear and be rapidly and easily uncoupled as needed without being lifted over the subject's head.

### SUMMARY

The following simplified summary is provided in order to disclose a basic understanding of some aspects of the claimed subject matter. This summary is not an extensive overview, and is not intended to identify key/critical elements or to delineate the scope of the claimed subject matter. Its purpose is to present some concepts in a simplified form as a prelude to the more detailed description that is presented later.

The present disclosure provides a device capable of being removed from a subject without having to be passed over the subject's head. In practice, the presently disclosed device imparts the ability to rapidly remove eyewear retained to a subject with a retention device without actually lifting the eyewear over the subject's head, hair, or associated headwear.

In one embodiment, a device for rapid detachment of eyewear comprises first and second fasteners, first and second rapid detachment mechanisms, and first and second band systems. Each fastener may be configured to removably attach to a temple retaining portion of the eyewear. Each rapid may be configured to removably attach to the other detachment mechanism. Each band system may comprise one or more bands, each having a proximal portion and a distal portion, wherein the proximal portion of each band system is mechanically attached to or comprises one of the fasteners, and the distal portion of each band system is attached to or comprises one of the detachment mechanisms. A predetermined movement causes the rapid detachment mechanisms to detach from each other.

In another embodiment, an eyewear detachment device comprises a first and second assembly, each assembly having an attachment mechanism for coupling to a temple retaining portion of an eyewear, at least one band coupled to the attachment mechanism with proximal and distal portions, the proximal portion in communication with the attachment mechanism, and a detachment mechanism disposed on the at least one band. The first and second assemblies removably couple to each other at respective detachment mechanisms so that a predetermined movement causes the detachment mechanisms to detach from each other.

The attachment mechanism may be bored out and configured to be slidably coupled to the temple retaining portion of the eyewear and/or it may be constructed from friction inducing material. The at least one band may be flexible, elastic, and/or constructed from metal, wire, rope, fabric, cloth, knit, bamboo, or twine. The at least one band may be integrally formed with the respective attachment mechanism.

The detachment mechanism may comprise at least one magnet and it may be integrally formed with the detachment mechanism itself. The at least one magnet may also be removably received by the detachment mechanism and may be movable between two or more predetermined locations on the at least one band. In some embodiments, the location of the detachment mechanism on the at least one band is adjustable.

The strength of the coupling formed between the detachment mechanisms may also be adjustable by modulating the number and/or strengths of magnet(s) comprised by a respective detachment mechanism, the distance between each opposing detachment mechanism, and/or respective material thickness of a magnet receiving chamber in the detachment mechanism. The at least one magnet may measure 6 mm by 3 mm and comprise neodymium. Further, between 0.8 to 1.2 pounds of force may be sufficient to uncouple the detachment mechanisms and preferably, approximately 1.0 pounds of force may uncouple the detachment mechanisms.

A method of rapidly detaching eyewear from a subject, the eyewear being coupled to an eyewear retainer, the steps including: donning the eyewear coupled to the eyewear retainer on the subject, wherein the eyewear retainer comprises a first and second assembly, each assembly having: an attachment mechanism for coupling to a temple retaining portion of the eyewear; at least one band coupled to the attachment mechanism with proximal and distal portions, the proximal portion in communication with the attachment mechanism; and a detachment mechanism disposed on the at least one band; wherein the first and second assemblies removably couple to each other at respective detachment mechanisms; and moving one or both of the detachment mechanisms to rapidly detach from each other. The subject in the above method may be a human. The bands of the eyewear retainer may also pass behind the subject.

In other embodiments, a method of detaching eyewear is disclosed, the method comprising: attaching a first and second assembly to eyewear, each assembly comprising (a) an attachment mechanism for coupling to a temple retaining portion of the eyewear; (b) at least one band coupled to the attachment mechanism with proximal and distal portions, the proximal portion in communication with the attachment mechanism; and (c) a detachment mechanism disposed on the at least one band. The method also includes removably coupling first and second assemblies to each other at respective detachment mechanisms; and moving one or both of the detachment mechanisms to rapidly detach each assembly from the other.

The method can also include a subject donning the eyewear, wherein the subject is a human. The bands of the assemblies may be specifically designed to pass behind the subject though the method is not so limited and the bands may pass in any manner or orientation as needed or required.

The method may also include attaching a pair of first and second assemblies to a first eyewear, each assembly of the first eyewear having: (a) an attachment mechanism for coupling to a temple retaining portion of the first eyewear; (b) at least one band coupled to the attachment mechanism with proximal and distal portions, the proximal portion in communication with the attachment mechanism; and (c) a detachment mechanism disposed on the at least one band. In this respect, the method may also include attaching the first and second assemblies to each other at respective detachment mechanisms; and moving one or both of the detachment mechanisms to rapidly detach from each other.

The disclosed embodiments are particularly advantageous since they allow a subject to be able to remove the eyewear without having to pass it, for example, over the subject's head or remove it from the eyewear altogether.

To the accomplishment of the foregoing and related ends, certain illustrative aspects are described herein in connection with the following description and the annexed drawings. These aspects are indicative, however, of but a few of the various ways in which the principles of the claimed subject matter may be employed and the claimed subject matter is intended to include all such aspects and their equivalents. Other advantages and novel features may become apparent from the following detailed description when considered in conjunction with the drawings.

At the same time, various elements of the device described herein may be slightly altered for various different features and various different or altered uses thereof, and these predicated changes and alterations are fully contemplated within the principles of the present disclosed improvements.

### BRIEF DESCRIPTION OF THE DRAWINGS

FIG. 1 is a perspective view of an exemplary set of eyewear for purposes of depicting typical features of eyewear.

FIG. 2 is a top elevation perspective view of eyewear when an exemplary detachment mechanism is operatively connected to an eyewear retainer, wherein the detachment mechanism is in an uncoupled state.

FIGS. 3A to 3B depict a detachment mechanism in one embodiment operatively connected to an eyewear retainer, wherein the detachment mechanism is in a coupled state in FIG. 3A and an uncoupled state in FIG. 3B.

FIGS. 4A to 4B depict a detachment mechanism in one embodiment operatively connected to an eyewear retainer, wherein the location, size, and strength of the detachment mechanism is adjustable.

FIG. 5 depicts the detachment mechanism in an embodiment with an adjustable location, size, and strength.

FIG. 6 depicts a close up view of an exemplary embodiment of the detachment mechanism of FIG. 5.

FIGS. 7A and 7B depict a side profile view of one embodiment of the device herein as worn by a subject with a pony tail in a coupled state and an uncoupled state.

FIG. 8 depicts another exemplary embodiment of the device with multiple retainer mechanisms.

FIG. 9 depicts a close up view of the embodiment of FIG. 8 taken along section 9-9.

### DETAILED DESCRIPTION

The device of the present disclosure may be economically molded by using one or more distinct parts to form the temple attachment mechanism, band system, and detachment mechanism which, when assembled together in an economical fashion, may form the device regardless of the particular form.

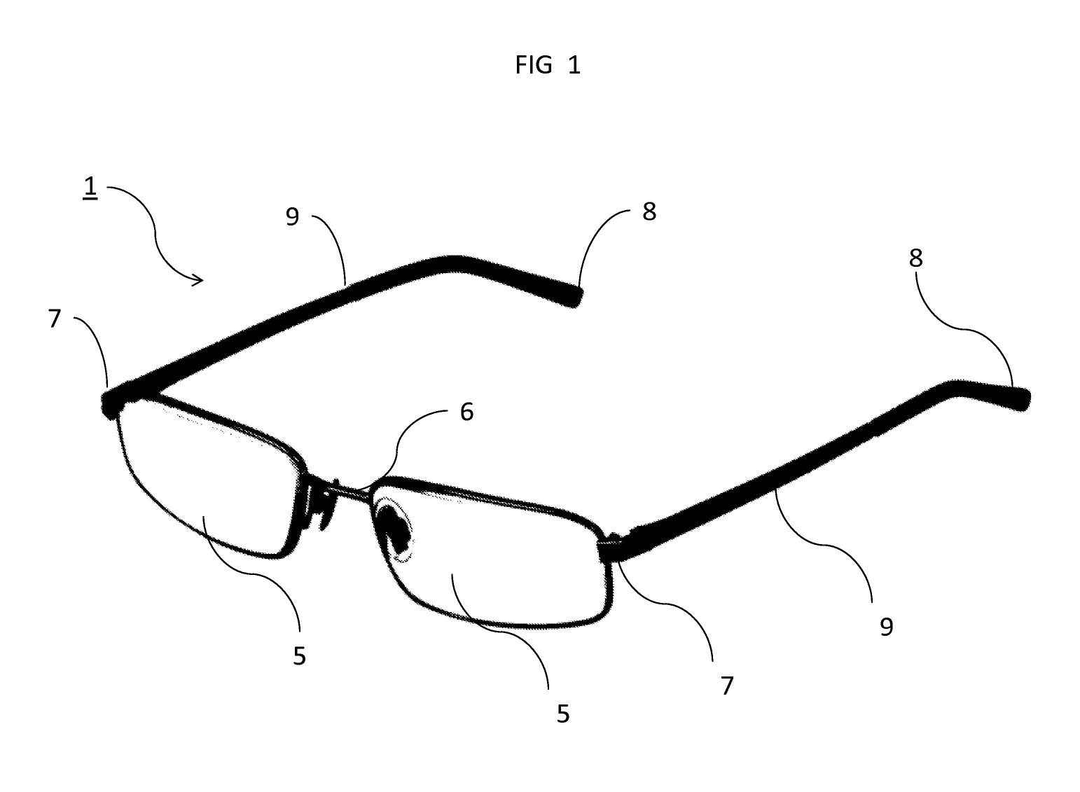

Referring to the figures herein for a better understanding, FIG. 1 demonstrates a typical article of eyewear 1. It can be seen that eyewear 1 may include one or more lenses 5 to cover the subject's eyes, an optional bridge portion 6 that sits on or above the ridge of the subject's nose, and a pair of elongated members 9 that extend from the face of the subject rearwards towards the ears and terminating in temple retaining portions 8 adjacent to the temple section of the subject.

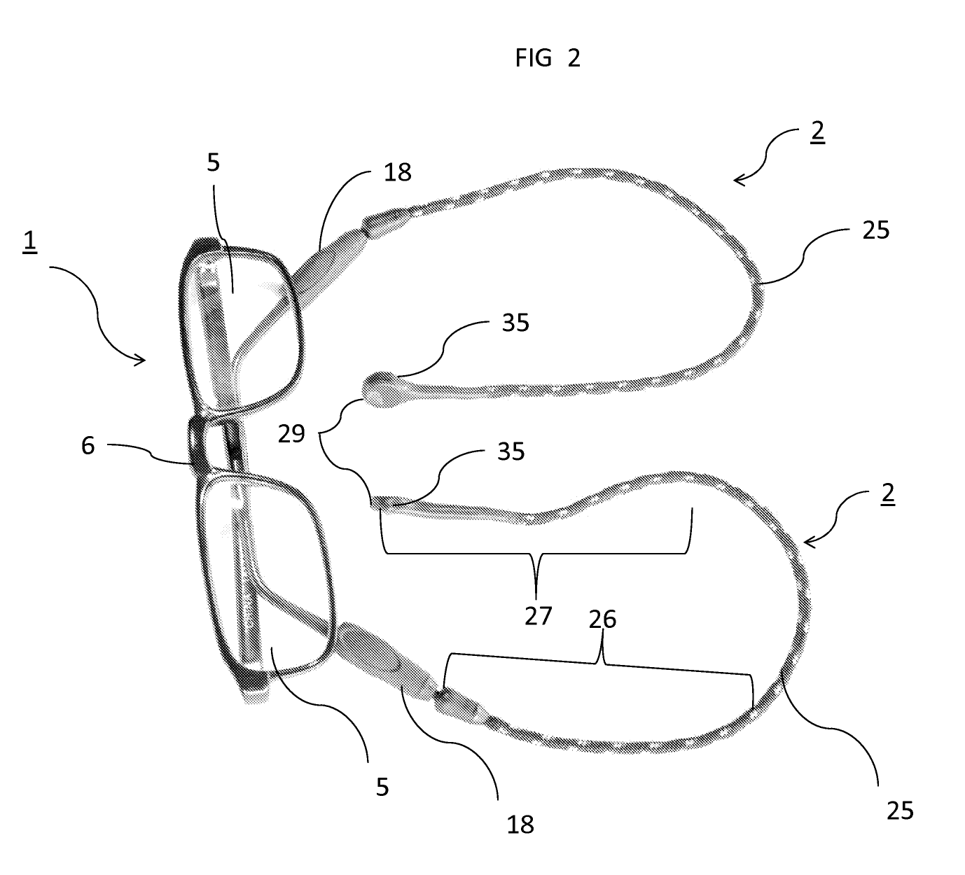

Turning to FIG. 2, one embodiment of an eyewear detachment assembly 2 is depicted when operatively coupled to eyewear 1. An assembly 2 is provided for each member 9 and associated temple retaining portion 8 of eyewear 1. Each assembly 2 may comprise a temple attachment mechanism 18 configured to removably attach assembly 2 to portion 8 of eyewear 1. A band system 25 mechanically connects to mechanism 18 extending therefrom towards the rear of the subject which in some cases may be the back, the neck, the rear portion of the subject's neck, or any other location as needed or required by the subject.

Band system 25 may comprise one or more flexible, resilient, and/or pliable bands that may be constructed from materials such as fabric, steam bent bamboo, plastic coated stainless steel wire, or any other applicable material as desired or needed. It is understood that band as described herein means one or more bands, cables, leashes, ropes, articles of twine, wires, chains, or the like. Bands of band system 25 may be relatively tightly wound and/or coated for increased tensile strength, resilience, and insulation. Band system 25 comprises a proximal portion 26 which is the portion of band system 25 that couples to portion 8 of eyewear 1. Band system 25 further comprises a distal portion 27 which is the portion of band system 25 opposite proximal portion 26.

Mechanism 18 may operatively connect to portion 8 of eyewear 1 by slidably connecting thereto. Mechanism 18 may be integrally formed with band system 25 or removably attached thereto. Moreover, mechanism 18 may comprise a bored out section with an inner area greater than an opposing outer area of portion 8. Mechanism 18 may be generally tubular and relatively flexible with friction inducing material such as rubber or silicone so that when mechanism 18 slidably connects to portion 8, mechanism 18 is naturally inclined to be retained thereon. In other embodiments, mechanism 18 may be configured to rotably fasten onto portion 8, be snap fitted thereon, or any other removable fastening engagement known in the art.

As can be seen in FIG. 2, detachment mechanism 35 may be disposed on distal portion 27 of band system 25. Since eyewear 1 comprises two portions 8 to which respective assemblies 2 operatively couple, detachment mechanism 35 of each provided assembly 2 is configured to easily, rapidly, and mechanically attach to opposing mechanism 35 and then detach as needed. Mechanism 35 may comprise any type of mounting or fastening engagement that is easy and rapidly detachable. Accordingly, mechanism 35 may comprise threaded fasteners, locks, snap fit buttons, hook and loop engagements, clamps, dowels, pins, universal joints, latches, or the like. Mechanism 35 may be fixedly attached to a predetermined location on the distal portion 27 of bands 25 including distal end 29. Mechanism 35 may be slidably attached between one or more predetermined positions so that the ultimate distance between mechanisms 18 and 35 is adjustable as needed or desired as explained more particularly below.

Preferably, detachment mechanism 35 may comprise relatively small but strong magnets to provide operative coupling between mechanisms 35 of each opposing assembly 2. The magnetic material comprised by detachment mechanism 35 may be in isolation or some combination of ferromagnetic metals such as ores including iron ores (magnetite or lodestone), cobalt, nickel, gadolinium and dysprosium or aluminum. The magnetic material of the detachment mechanism may be sintered or formed by casting and may be corrosion resistant. The magnet material of detachment mechanism 35 may additionally be constructed from ceramics with powdered iron oxides and/or barium/strontium carbonate. The magnetic material may also be injection molded and therefore be formed as a composite with a suitable resin and powder mixture, wherein magnetic strength and shape are customized and adjusted according to design need or preference.

Preferably, the magnetic material of mechanism 35 may be neodymium and is positioned in a receiver in mechanism 35. The magnets may be of any useable size and/or strength as described herein. This allows the band system 25 to be rapidly and easily separated into two independent portions which advantageously facilitates rapid and easy detachment of eyewear 1 from the subject without having to be passed over the subject's head. Positioning magnets in mechanism 35 provides an operative coupling that is rapidly and easily achieved by the subject simply by placing mechanisms 35 in communication with each other. Likewise, coupling between mechanisms 35 once formed can be uncoupled in this embodiment through a predetermined movement such as pulling, pushing, sliding one or both of the detachment mechanisms 35 or the like. Alternatively, once the eyewear 1 and assemblies 2 are donned by the subject and each mechanism 35 is coupled but then desired to be removed, the subject may simply utilize a predetermined movement to move the eyewear so that the band systems 25 of assemblies 2 contact the rear portion of the neck or head of the subject so that the mechanisms 35 rapidly and easily detach from each other.

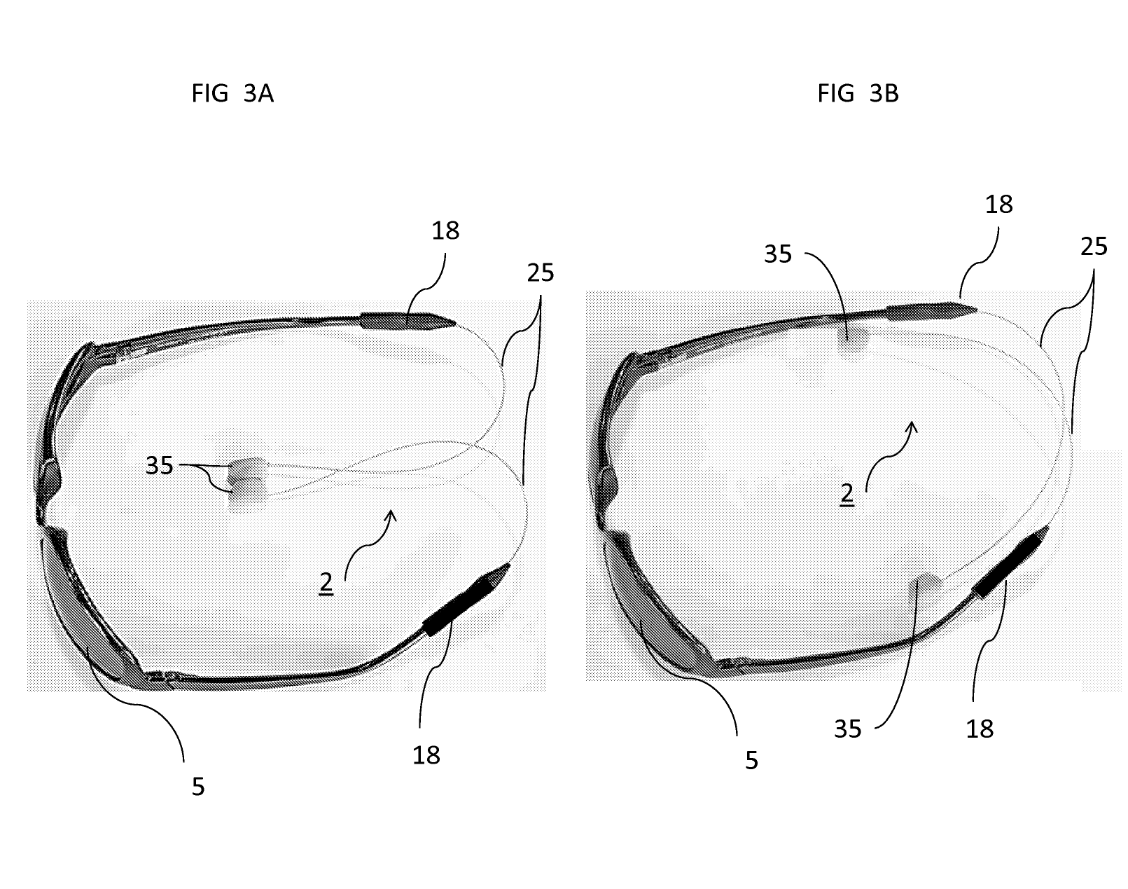

FIGS. 3A and 3B depict another embodiment of assembly 2 when attached to sunglasses 2. It can be seen that mechanisms 18 each slidably attach to portions 8 of sunglasses 2, wherein bands 25 of each respective assembly 2 extend rearwards from mechanism 18 towards respective mechanism 35. Bands 25 are depicted as being relatively flexible yet resilient so as to bend and conform to the shapes needed by the subject to wrap behind the subject's head. FIG. 3A depicts mechanisms 35 in communication with each other and therefore in a coupled state. FIG. 3B depicts sunglasses 1 and assemblies 2, wherein mechanisms 35 are in an uncoupled state after they have been easily and rapidly detached so that mechanisms 35 are no longer in communication with each other.

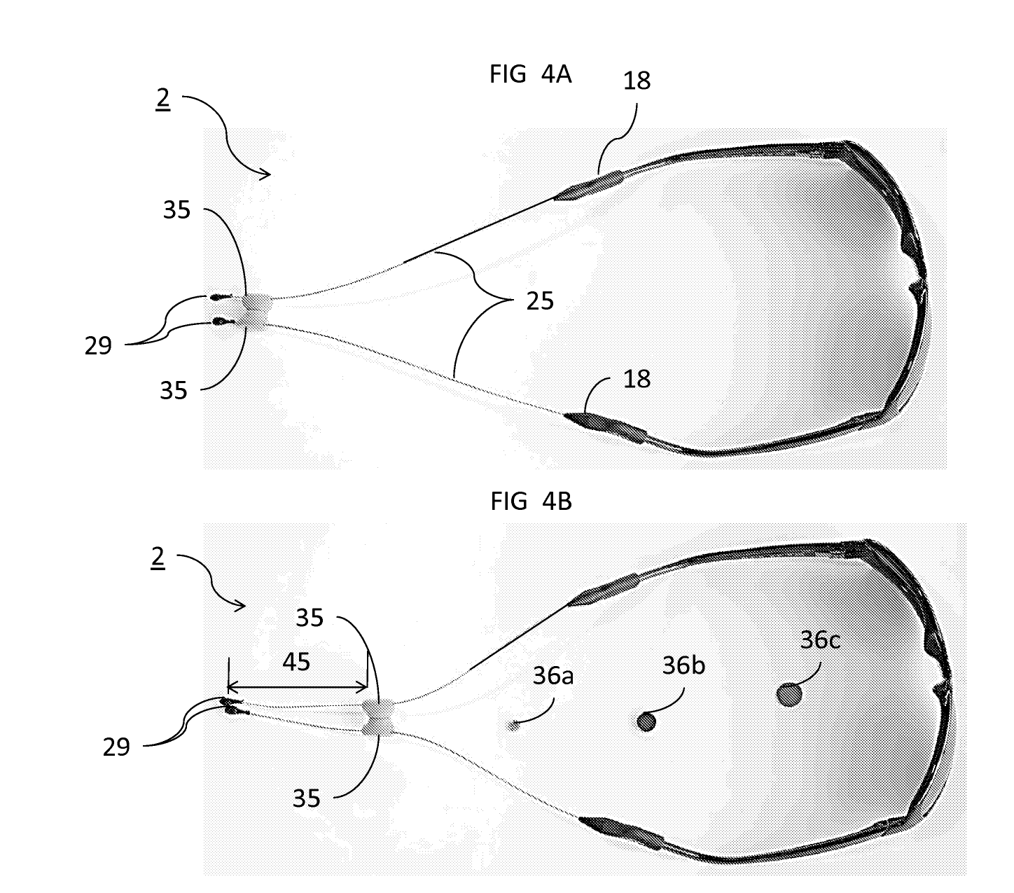

FIGS. 4A and 4B similarly depict sunglasses 1 attached to respective assemblies 2, wherein mechanisms 35 are capable of being adjusted in multiple respects. As previously described, the location of mechanism 35 on band 25 may be adjustable as can be seen between FIGS. 4A and 4B. Mechanisms 35 are moved between multiple predetermined locations across distance 45. This is particularly advantageous since subjects of various sizes and needs are able to use one single eyewear retainer system (e.g. different headwear, head size, and/or hair size). It can be seen in FIG. 4A that in a coupled state, mechanisms 35 are positioned adjacent to distal ends 29 of respective bands 25. However, it may be that the subject wishes to more securely don sunglasses 1 by increasing the tension in bands 25 by reducing the total band distance between respective mechanisms 18 and 35. In this case, FIG. 4B depicts mechanisms 35 after they have been adjusted to be positioned closer to respective mechanisms 18.

In this embodiment, mechanism 35 is also configured to receive magnets 36 which may be relatively smaller and of weaker strength 36a, relatively larger and of increased strength 36c, or a magnet designed somewhere in between 36b. Since magnets 36 of mechanism 35 may not be integrally formed therein, the subject can adjust the ultimate coupling strength of respective mechanism 35 as needed or required by adding or removing magnets as required or needed.

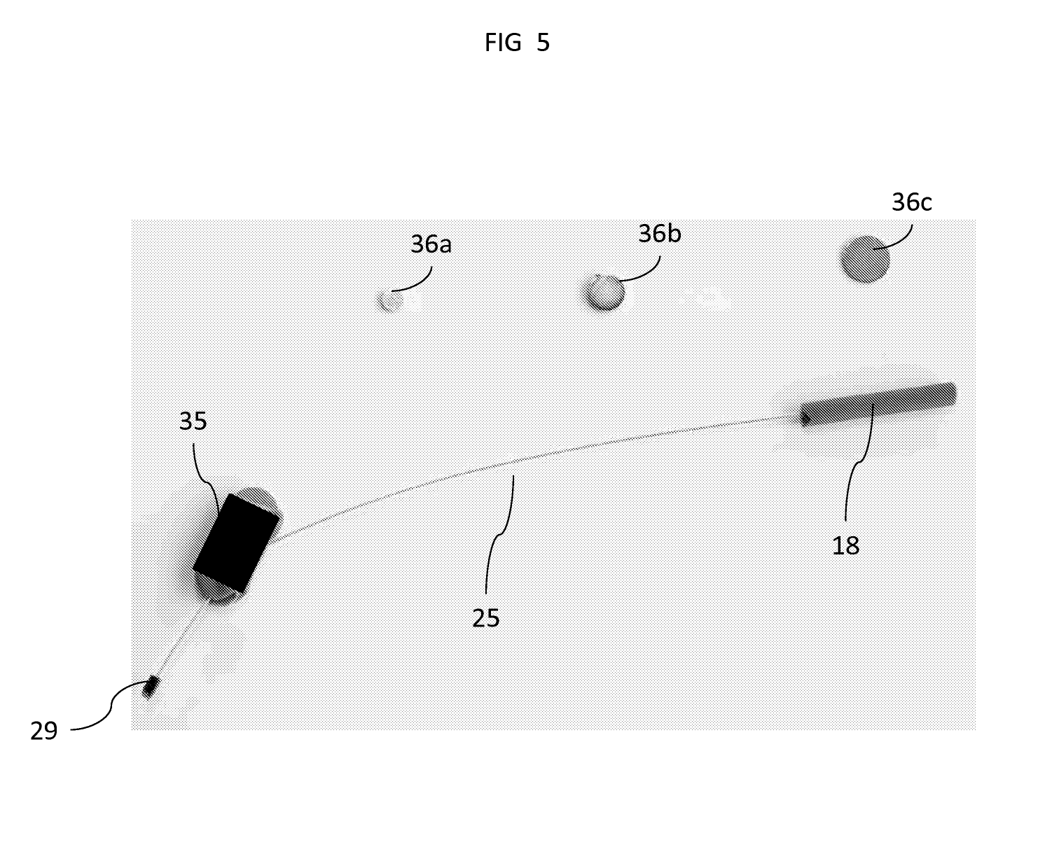

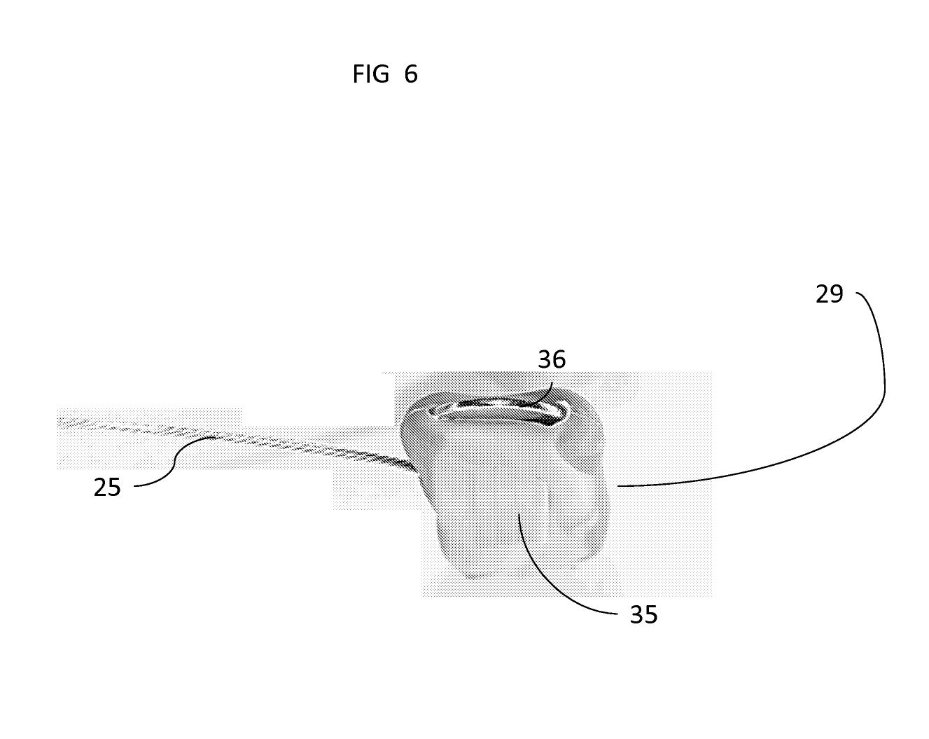

FIG. 5 depicts a close up view of another embodiment wherein the location and coupling strength of mechanism 35 may be adjusted as needed or required. It can be seen that the location of mechanism 35 may adjusted by sliding mechanism 35 along band 25 towards distal end 29 or alternatively, towards mechanism 18 as needed or required. Further, mechanism 35 may be configured to receive any number of different magnets of various sizes and strengths including the one or more magnets 36a, 36b, and/or 36c. In this respect, mechanism 35 may include a magnet receiving chamber into which the one or more magnets 36 can be inserted and received. Further, mechanism 35 may include a magnet retaining mechanism such as a hinged door, band, cap, or the like to secure the magnets 36 therein once received by mechanism 35. FIG. 6 depicts a close up view of mechanism 35 as described where it is seen that magnet 36 has been received by the chamber of mechanism 35.

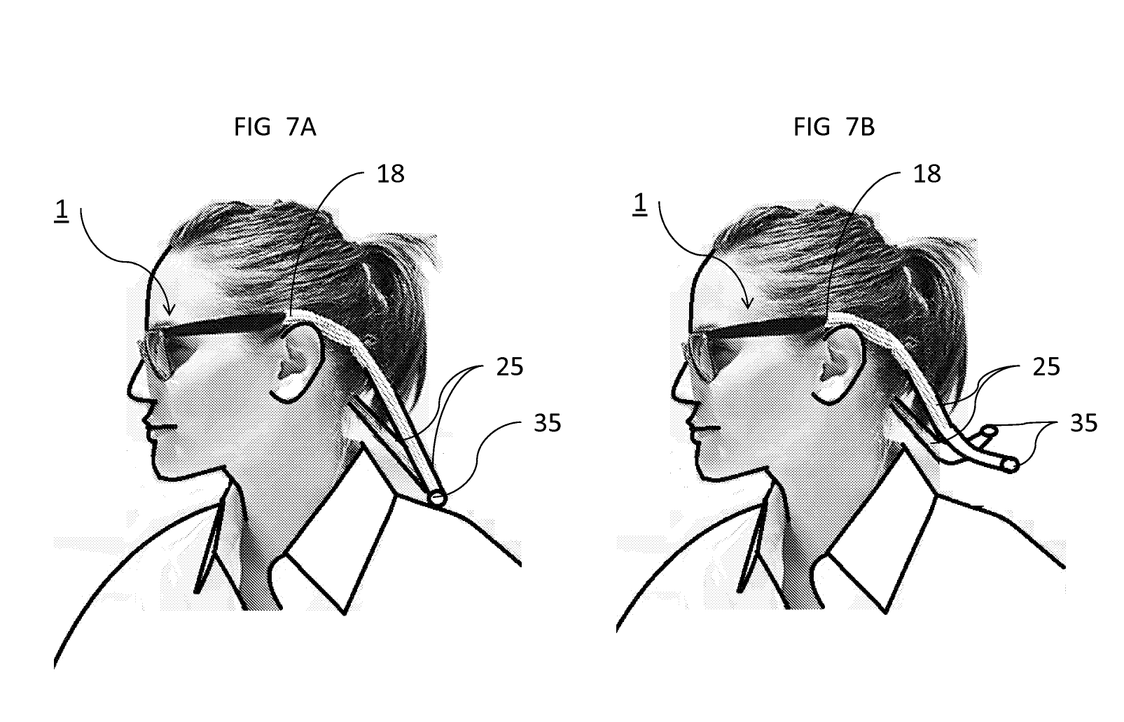

FIGS. 7A and 7B describe assemblies 2 as applied more particularly to a subject who has longer hair including a pony tail. Eyewear 1 and assemblies 2 are seen donned by the subject, wherein FIG. 7A shows that the subject has maneuvered each assembly 2 so that respective mechanisms 35 contact each other to operatively couple. The subject may now proceed with any given task such as walking, running, hiking, or undergoing any other type of professional or recreational activity where eyewear retention is preferred or needed.

Since the subject has long hair but could also be wearing headwear such as a hat or the like, to remove eyewear 1 and assemblies 2, the subject easily and rapidly detaches mechanisms 35 from each other by pulling them apart in one simple movement (See FIG. 7B). In other embodiments, mechanisms 35 may be detached from each other by unsnapping, unsheathing, or otherwise unfastening each mechanism 35 from the other so that eyewear 1 and assemblies 2 may be removed from the subject without having to be lifted over the subject's head.

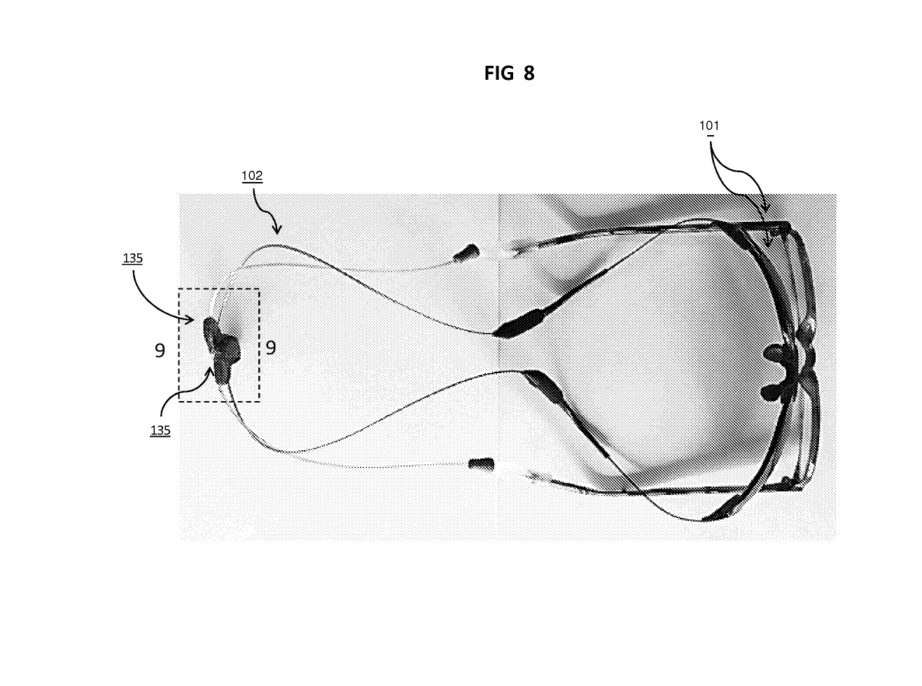

Turning to FIG. 8 is another embodiment wherein multiple eyewear 1 and assemblies 2 are provided where environments may require multiple eyewear devices 1 for different applications. For example, it may be advantageous for one type of eyewear 1 adapted for use in relatively high sunlight while simultaneously having to utilize eyewear 1 design for reading (e.g. sunglasses and reading glasses). The herein disclosed solution is not so limited, however, such that assembly 2 can be used with any number of eyewear 1 adapted for any number of uses such as surgeon eyewear, protective eyewear, recreational eyewear, or the like. In this respect, a user may find it advantageous to don multiple eyewear 1 devices in concert with the herein disclosed assemblies 2 to streamline efficiency for multiple uses as well as mitigate lost time due to having to store and locate different eyewear for specific applications. Any number of eyewear 1 devices can be donned by the user and used as described herein.

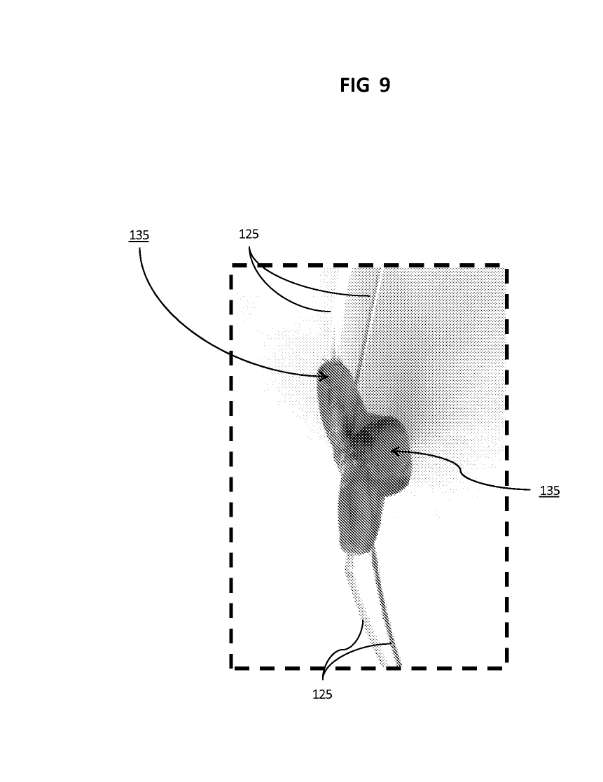

In order to teach multiple eyewear 1 that readily and rapidly detachable, multiple associated assemblies 2 may be provided in communication with each eyewear 1. Alternatively, multiple eyewear 1 may be coupled at through modified assembly 102 and a single detachment mechanism 135 for adjoining modified assembly 102. It is understood that all features of FIGS. 8 and 9 with similar feature numbers of FIGS. 1-7 function similarly or equally. It is noted that FIG. 8 depicts alternative systems 102 operatively coupling associated band systems 125 into single detachment mechanisms 135 and FIG. 9 depicts a close-up view of exemplary detachment mechanisms 135.

As can be seen, assembly 102 operatively couples to each other through corresponding detachment mechanisms 135, similar to assembly 2 of FIGS. 1-7. However, detachment mechanisms 135 of FIGS. 8-9 are designed to receive each band system 125 of corresponding eyewear 101 into a single connection point, area, or portion. While FIGS. 8-9 depicts only two distinct band systems 125 of corresponding eyewear 101, the herein described solution is not so limited and any number of eyewear 101 with corresponding band systems 125 may be provided to be operatively coupled to mechanisms 135. In this respect, each mechanism 135 is designed to easily, rapidly, and mechanically attach to opposing mechanism 135 of any number of eyewear and then detach as needed.

Similar to mechanism 35, mechanism 135 may comprise any of the herein described mounting or fastening engagements. Thus, mechanism 135 may comprise one or more magnetic inserts or fasteners, threaded fasteners, locks, snap fit buttons, hook and loop engagements, clamps, dowels, pins, universal joints, latches, or the like. Mechanism 135 may also be fixedly attached to a predetermined location on the distal portion 127 of bands 125 including distal end 129 itself. Similar to mechanism 35, mechanism 135 may also be slidably attached between one or more predetermined positions so that the ultimate distance between mechanisms 118 and 135 is adjustable as needed or desired.

Many alterations and modifications may be made by those having ordinary skill in the art without departing from the spirit and scope of the embodiments disclosed and described herein. Therefore, it is understood that the illustrated and described embodiments have been set forth only for the purposes of examples and that they are not to be taken as limiting the embodiments as defined by the following claims. For example, notwithstanding the fact that the elements of a claim are set forth below in a certain combination, it must be expressly understood that the embodiments include other combinations of fewer, more or different elements, which are disclosed above even when not initially claimed in such combinations.

The definitions of the words or elements of the following claims are, therefore, defined in this specification to not only include the combination of elements which are literally set forth. It is also contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination(s).

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements. The claims are thus to be understood to include what is specifically illustrated and described above, what is conceptually equivalent, what can be obviously substituted and also what incorporates the essential idea of the embodiments.

What has been described above includes examples of one or more embodiments. It is, of course, not possible to describe every conceivable combination of components or methodologies for purposes of describing the aforementioned embodiments, but one of ordinary skill in the art may recognize that many further combinations and permutations of various embodiments are possible. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. (canceled)

2. An eyewear detachment device, comprising
a first and second assembly, each assembly having:
an attachment mechanism for coupling to a temple retaining portion of an eyewear;
at least one band coupled to the attachment mechanism with proximal and distal portions, the proximal portion in communication with the attachment mechanism; and
a detachment mechanism disposed on the at least one band;
wherein the first and second assemblies removably couple to each other at respective detachment mechanisms, and wherein a predetermined movement causes the detachment mechanisms to rapidly detach from each other.

3. The device of claim 2, wherein the attachment mechanism is bored out and configured to be slidably coupled to the temple retaining portion of the eyewear.

4. The device of claim 2, wherein the attachment mechanism is constructed from friction inducing material.

5. The device of claim 2, wherein the at least one band is flexible.

6. The device of claim 2, wherein the at least one band is elastic.

7. The device of claim 2, wherein the at least one band is constructed from metal, wire, rope, fabric, cloth, knit, bamboo, or twine.

8. The device of claim 2, wherein the at least one band is integrally formed with the respective attachment mechanism.

9. The device of claim 2, wherein the detachment mechanism comprises at least one magnet.

10. The device of claim 9, wherein the at least one magnet is integrally formed with the detachment mechanism.

11. The device of claim 9, wherein the at least one magnet is removably received by the detachment mechanism.

12. The device of claim 2, wherein the detachment mechanism is movable between two or more predetermined locations on the at least one band.

13. The device of claim 2, wherein a location of the detachment mechanism on the at least one band is adjustable.

14. The device of claim 2, wherein a strength of the coupling formed between the detachment mechanisms is adjustable.

15. The device of claim 2, wherein the device is operatively connected to the eyewear.

16. A method of detaching eyewear, comprising:
attaching a first and second assembly to eyewear, each assembly comprising (a) an attachment mechanism for coupling to a temple retaining portion of the eyewear; (b) at least one band coupled to the attachment mechanism with proximal and distal portions, the proximal portion in communication with the attachment mechanism; and (c) a detachment mechanism disposed on the at least one band;
removably coupling first and second assemblies to each other at respective detachment mechanisms; and
moving one or both of the detachment mechanisms to rapidly detach each assembly from the other.

17. The method according to claim 16, further comprising: a subject donning the eyewear, wherein the subject is a human.

18. The method according to claim 17, wherein the bands of the assemblies pass behind the subject.

19. A method of forming a mechanism for detaching eyewear, the method comprising:
attaching a pair of first and second assemblies to a first eyewear, each assembly of the first eyewear having: (a) an attachment mechanism for coupling to a temple retaining portion of the first eyewear; (b) at least one band coupled to the attachment mechanism with proximal and distal portions, the proximal portion in communication with the attachment mechanism; and (c) a detachment mechanism disposed on the at least one band;
attaching the first and second assemblies to each other at respective detachment mechanisms; and
moving one or both of the detachment mechanisms to rapidly detach from each other.

20. The method of claim 19, further comprising:
Attaching a second pair of first and second assemblies to a second eyewear, each assembly of the second eyewear having: (a) an attachment mechanism for coupling to a temple retaining portion of the second eyewear; (b) at least one band coupled to the attachment mechanism with proximal and distal portions, the proximal portion in communication with the attachment mechanism; and (c) a detachment mechanism disposed on the at least one band;
attaching the assemblies of the second eyewear to each other at respective detachment mechanisms of the first eyewear; and
moving one or both of the detachment mechanisms of the first and second eyewear to rapidly detach from each other.
